(19) United States
(12) Patent Application Publication
(10) Pub. No.: US 2015/0137645 A1
(43) Pub. Date: May 21, 2015

(54) SPINDLE MOTOR

(71) Applicant: SAMSUNG ELECTRO-MECHANICS CO., LTD., Suwon-Si (KR)

(72) Inventor: Nam Ki PARK, Suwon-Si (KR)

(73) Assignee: SAMSUNG ELECTRO-MECHANICS CO., LTD., Suwon-Si (KR)

(21) Appl. No.: 14/543,904

(22) Filed: Nov. 18, 2014

(30) Foreign Application Priority Data
Nov. 21, 2013 (KR) 10-2013-0142484

(51) Int. Cl. H02K 1/12

(52) U.S. Cl. CPC H02K 1/12
USPC 310/156.01

(57) ABSTRACT

A spindle motor may include: a sleeve rotatably supporting a shaft; a rotor coupled to the shaft and rotating together therewith; and a base member fixedly coupled to the sleeve, wherein the base member includes a plurality of penetration holes formed therein so as to penetrate therethrough, and a magnetic material is inserted into at least one of the plurality of penetration holes, and non-magnetic materials are inserted into the remaining penetration holes.

### CROSS-REFERENCE TO RELATED APPLICATION

This application claims the benefit of Korean Patent Application No. 10-2013-0142484 filed on Nov. 21, 2013, with the Korean Intellectual Property Office, the disclosure of which is incorporated herein by reference.

### BACKGROUND

The present disclosure relates to a spindle motor.

A hard disk drive (HDD), an information storage devices used in the field of computing, reads data stored on a disk or writes data to a disk using a magnetic head.

In hard disk drives, a spindle motor is used.

Spindle motors commonly have a hydrodynamic bearing assembly, and are used to rotate disks mounted thereon while supporting the rotation of a rotating member through fluid pressure generated by the hydrodynamic bearing assembly.

Here, in the case in which such a rotating member is rotated in a state in which it is inclined, it may have a negative influence on performance of the spindle motor. Therefore, it is preferable that a rotating member be rotated while maintaining an angle of inclination of 0°, relative to fixed members, at the time of rotation of the spindle motor.

Recently, in accordance with increased demand for spindle motors having high rotational precision, it has become important to manage the angle of inclination of a rotating member, relative to fixed members, at the time of rotation of the spindle motor.

### SUMMARY

An aspect of the present disclosure may provide a spindle motor capable of preventing a rotating member from rotating in a state in which it is inclined, relative to fixed members, at the time of rotation of the spindle motor.

According to an aspect of the present disclosure, a spindle motor may include: a sleeve rotatably supporting a shaft; a rotor coupled to the shaft and rotating together therewith; and a base member having the sleeve fixedly coupled thereto, wherein the base member includes a plurality of penetration holes formed therein so as to penetrate therethrough, and a magnetic material is inserted into at least one of the plurality of penetration holes, and non-magnetic materials are inserted into the remaining penetration holes.

The base member may be formed by plastically deforming a steel sheet.

The penetration holes may partially protrude from an upper surface of the base member.

The rotor may have a magnet mounted on an inner peripheral surface thereof, and the magnetic material may be disposed in a position corresponding to that of the magnet.

The magnetic material may be disposed in a position corresponding to a portion of the rotor inclined in an upward axial direction.

According to another aspect of the present disclosure, a spindle motor may include: a sleeve rotatably supporting a shaft; a rotor coupled to the shaft, rotating together therewith, and a having a magnet mounted on an inner peripheral surface thereof; and a base member having the sleeve fixedly coupled thereto, wherein the base member is provided with a magnetic material to generate asymmetric pulling force between the magnetic material and the magnet.

The base member may include a plurality of insertion grooves formed therein, and the magnetic material may be inserted into at least one of the plurality of insertion grooves.

The insertion grooves may be recessed from a lower surface of the base member toward an upper surface of the base member.

Non-magnetic materials may be inserted into the insertion grooves other than the insertion groove into which the magnetic material is inserted among the plurality of insertion grooves.

The magnetic material may be disposed in a position corresponding to that of the magnet.

The magnetic material may be disposed in a position corresponding to a portion of the rotor inclined in an upward axial direction.

### BRIEF DESCRIPTION OF DRAWINGS

The above and other aspects, features and other advantages of the present disclosure will be more clearly understood from the following detailed description taken in conjunction with the accompanying drawings, in which:

FIG. 1A is a conceptual diagram illustrating a state in which an angle of inclination of a rotating member, relative to fixed members of a spindle motor, is maintained at 0°;

FIG. 1B is a conceptual diagram illustrating a manner in which the rotating member is coupled to the fixed member in a state in which it is inclined;

FIG. 2A is a perspective view illustrating a manner in which a spindle motor is coupled to a base member according to an exemplary embodiment in the present disclosure;

FIG. 2B is a perspective view of a base member according to an exemplary embodiment in the present disclosure;

FIG. 3 is a cross-sectional view taken along line A-A′ of FIG. 2A;

FIG. 4A is a perspective view illustrating a manner in which a spindle motor is coupled to a base member according to another exemplary embodiment in the present disclosure;

FIG. 4B is a perspective view of a base member according to another exemplary embodiment in the present disclosure; and

FIG. 5 is a cross-sectional view taken along line B-B′ of FIG. 4A.

### DETAILED DESCRIPTION

Hereinafter, embodiments in the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

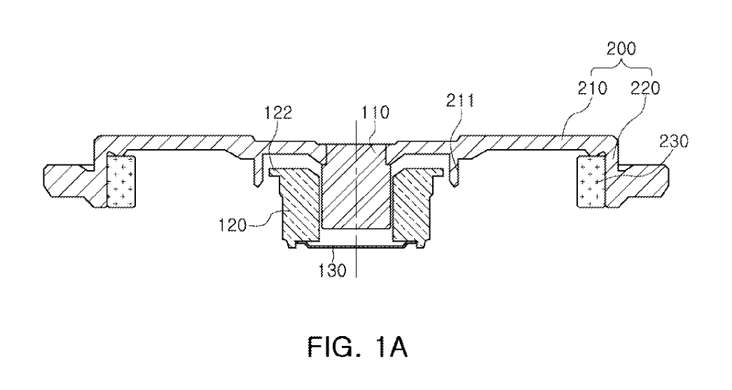

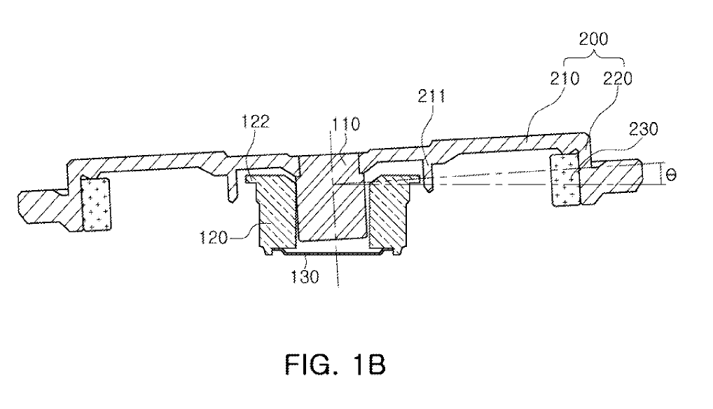

FIG. 1A is a conceptual diagram illustrating a state in which an angle of inclination of a rotating member, relative to fixed members of a spindle motor, is maintained at 0°; while FIG. 1B is a conceptual diagram illustrating a manner in which the rotating member is coupled to the fixed member in a state in which it is inclined relative thereto.

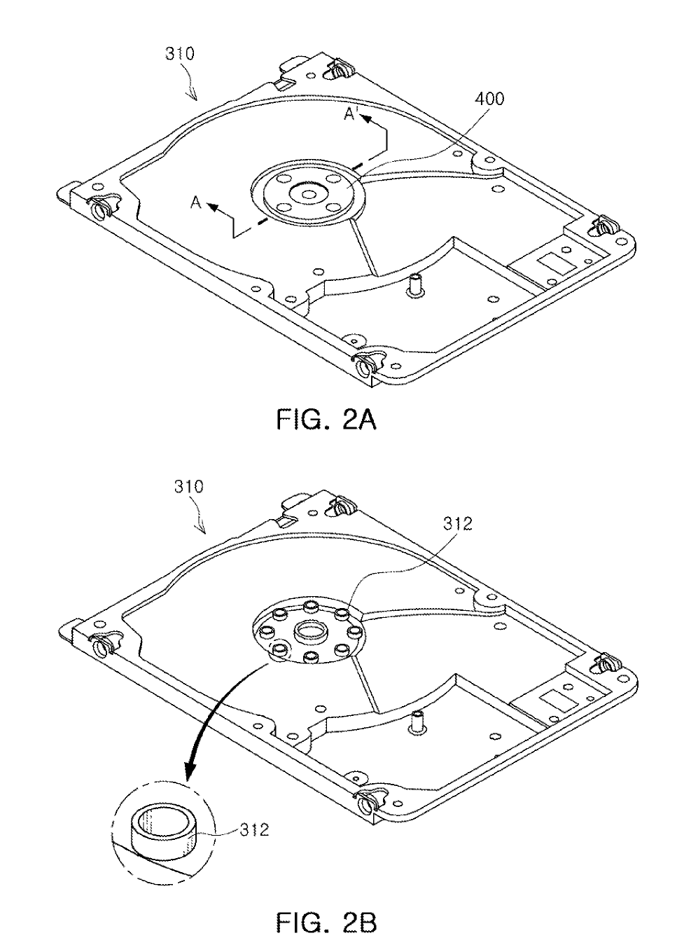

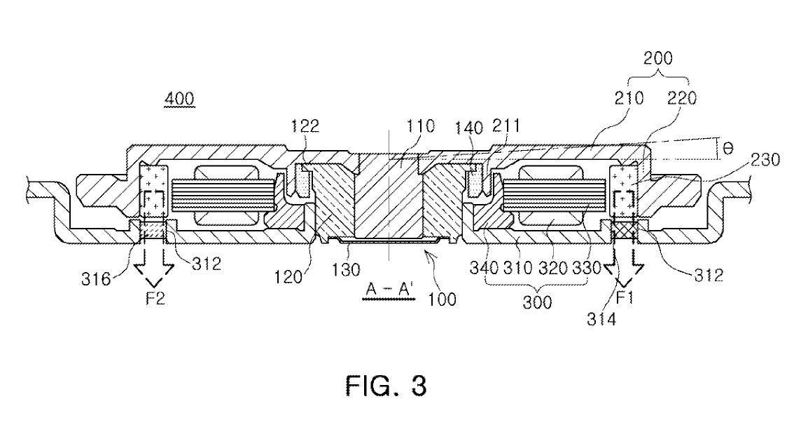

In addition, FIG. 2A is a perspective view illustrating a manner in which a spindle motor is coupled to a base member according to an exemplary embodiment in the present disclosure; FIG. 2B is a perspective view of a base member according to an exemplary embodiment in the present disclosure; and FIG. 3 is a cross-sectional view taken along line A-A′ of FIG. 2A.

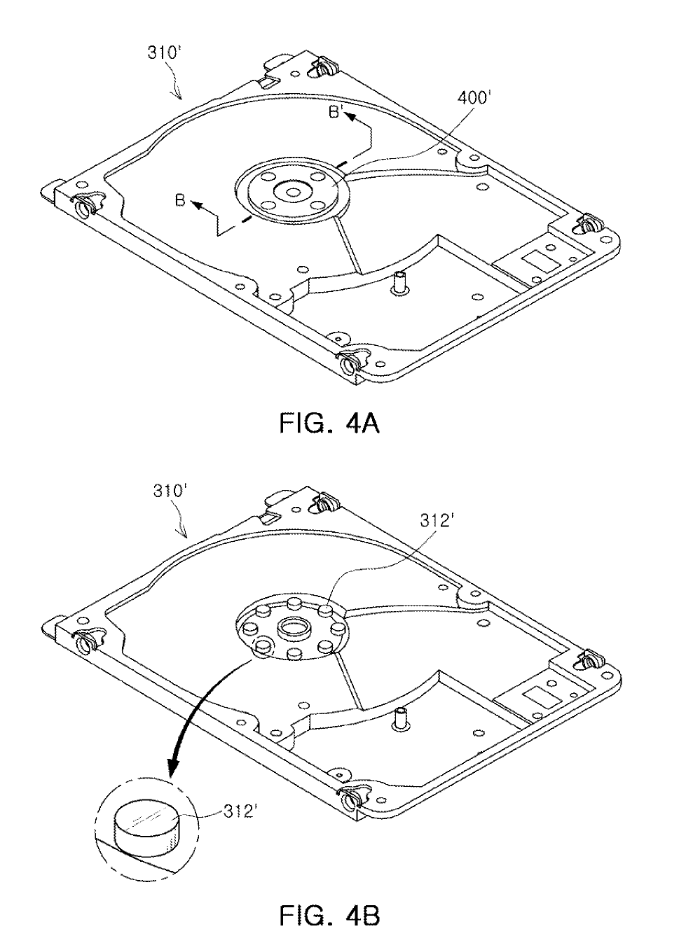

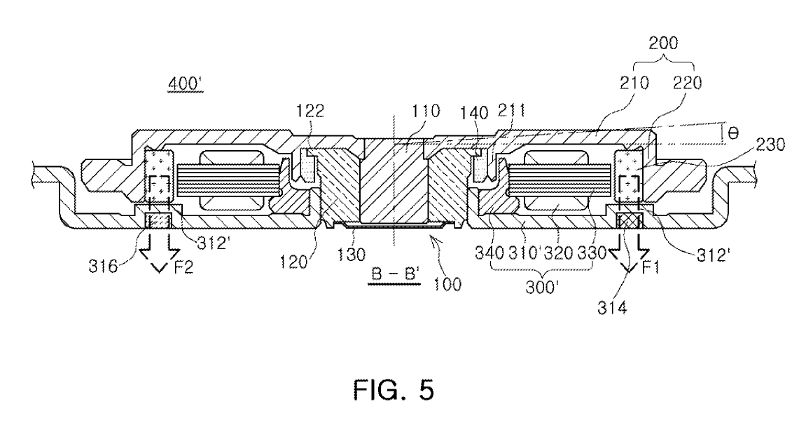

Further, FIG. 4A is a perspective view illustrating a manner in which a spindle motor is coupled to a base member according to another exemplary embodiment in the present disclosure; FIG. 4B is a perspective view of a base member according to another exemplary embodiment in the present disclosure; and FIG. 5 is a cross-sectional view taken along line B-B′ of FIG. 4A.

First referring to FIG. 3 or FIG. 5, a spindle motor 400 according to an exemplary embodiment in the present disclosure may include a hydrodynamic bearing assembly 100, a rotor 200, and a stator 300.

Terms with respect to directions will first be defined. As viewed in FIG. 3 or FIG. 5, an axial direction refers to a vertical direction based on a shaft 110, and an outer diameter or inner diameter direction refers to a direction towards an outer edge of the shaft 110 based on the shaft 110 or a direction towards the center of the shaft 110 based on the outer edge of the shaft 110.

In addition, a circumferential direction refers to a rotation direction along an outer peripheral surface of the rotor 200 or the shaft 110.

The hydrodynamic bearing assembly 100 may include the shaft 110, a sleeve 120, and a cover plate 130.

The sleeve 120 may support the shaft 110 so that an upper end of the shaft 110 protrudes in an upward axial direction and may be formed by forging Cu or Al or sintering a Cu-Fe-based alloy powder or an SUS-based powder.

Here, the shaft 110 may be inserted into a shaft hole of the sleeve 120 so as to have a micro clearance between the shaft 110 and the shaft hole of the sleeve 120. The micro clearance may be filled with a lubricating fluid, and rotation of the shaft 110 may be more smoothly supported by radial dynamic grooves (not shown) formed in at least one of an outer diameter of the shaft 110 and an inner diameter of the sleeve 120.

The radial dynamic grooves (not shown) may be formed in an inner peripheral surface of the sleeve 120, which is an inner portion of the shaft hole of the sleeve 120, and may generate pressure so that the shaft 110 may smoothly rotate in a state in which the shaft 110 is spaced apart from the inner peripheral surface of the sleeve 120 by a predetermined interval at the time of being rotated.

However, the radial dynamic grooves (not shown) are not limited to being formed in the inner peripheral surface of the sleeve 120 as described above, but may also be formed in an outer peripheral surface of the shaft 110. In addition, the number of radial dynamic grooves is not limited.

Here, the radial dynamic grooves (not shown) may have at least one of a herringbone pattern, a spiral pattern, and a helix pattern. However, the radial dynamic grooves may have any shape as long as they may generate radial dynamic pressure.

In addition, thrust dynamic grooves (not shown) may be formed in at least one of an upper surface of the sleeve 120 and one surface of the rotor 200 facing the upper surface of the sleeve 120, and the rotor 200 may rotate together with the shaft 110 in a state in which a predetermined degree of floating force may be secured by the thrust dynamic grooves (not shown).

Here, the thrust dynamic grooves (not shown) may have a herringbone pattern, a spiral pattern, or a helix pattern, similar to the radial dynamic grooves (not shown). However, the thrust dynamic grooves (not shown) are not necessarily limited to having the above-mentioned shape, but may have any shape as long as they may provide thrust dynamic pressure.

The cover plate 130 may be coupled to the sleeve 120 in a state in which it maintains a clearance between the cover plate 130 and a lower portion of the sleeve 120.

The cover plate 130 may accommodate the lubricating fluid in the clearance formed between the cover plate 130 and the sleeve 120 to serve as a bearing supporting a lower surface of the shaft 110.

Here, as a method of fixing the cover plate 130, there may be several methods such as a welding method, a caulking method, a bonding method, and the like, which may be selectively applied depending on a structure and a process of a product.

The rotor 200 may be a rotating member provided so as to be rotatable with respect to the stator 300 and may include an annular ring-shaped magnet 230 disposed on an inner peripheral surface thereof, wherein the annular ring-shaped magnet 230 corresponds to a core 330 while having a predetermined interval therebetween, and the core 330 has a coil 320 wound therearound.

Here, the rotor 200 may include a hub base 210 press-fitted onto and fixed to an upper end of the shaft 110 and a magnet supporting part 220 bent from the hub base 210 in a downward axial direction and supporting the magnet 230.

In addition, the magnet 230 may be a permanent magnet generating magnetic force having a predetermined degree of strength by alternately magnetizing an N pole and an S pole thereof in the circumferential direction.

Rotational driving of the rotor 200 will be schematically described hereinafter. When power is supplied to the coil 320 wound around the core 330, driving force capable of rotating the rotor 200 may be generated by electromagnetic interaction between the magnet 230 and the core 330 having the coil 320 wound therearound.

Therefore, the rotor 200 may rotate. As a result, the shaft 110 to which the rotor 200 is fixedly coupled may rotate together with the rotor 200.

The rotor 200 may be provided with a main wall part 211 protruding from one surface thereof in the downward axial direction.

The main wall part 211 may have a stopper 140 coupled to an inner peripheral surface thereof, and an inner peripheral surface of the stopper 140 and an outer peripheral surface of the sleeve 120 may have a sealing part formed therebetween in order to seal the lubricating fluid.

That is, the main wall part 211 may protrude from one surface of the rotor 200, which is a rotating member, to fix the stopper 140 to the inner peripheral surface thereof, and the lubricating fluid may be sealed between the stopper 140 and the sleeve 120, which is a fixed member.

The outer peripheral surface of the sleeve 120 corresponding to the inner peripheral surface of the stopper 140 may be tapered so that the lubricating fluid is sealed.

Here, an upper portion of the sleeve 120 maybe provided with a flange part 122 protruding in the outer diameter direction, and a lower surface of the flange part 122 may face a portion of an upper surface of the stopper 140.

Therefore, in the case in which the shaft 110 and the rotor 200, which are rotating members, are excessively floated, a portion of the upper surface of the stopper 140 may be caught by the lower surface of the flange part 122, whereby excessive floating of the rotating members may be prevented.

The stator 300, which is a fixed member supporting the rotation of the rotor 200 corresponding to the rotating member, may include the coil 320, the core 330, a stator holder 340, and a base member 310.

The stator 300 may be a fixed structure including the core 330 having the coil 320 wound therearound, wherein the coil 320 generates electromagnetic force having a predetermined magnitude at the time of applying power.

The core 330 maybe fixedly disposed over the base member 310 provided with a flexible printed circuit board (not shown) having pattern circuits printed thereon, the base member 310 corresponding to the core 330 having the coil 320 wound therearound may have a coil hole (not shown) formed therein so that a lead wire of the coil 320 passes therethrough, the coil hole having a predetermined size, and the coil 320 may be electrically connected to the flexible printed circuit board (not shown) so that external power is supplied.

The base member 310 may have the stator holder 340 coupled thereto, and the stator holder 340 may have the core 330 fixed thereto.

An outer peripheral surface of the stator holder 340 may be stepped so that the core 330 is stably fixed thereto.

The base member 310 may be manufactured by plastically deforming (for example, press working) a steel sheet.

In detail, the base member 310 may be manufactured by performing plastic working on a sheet, that is, a cold rolled steel sheet (SPCC, SPCE, or the like), a hot rolled steel sheet, stainless steel, or lightweight alloy steel sheet such as a boron or magnesium alloy, or the like.

Hereinafter, a method of improving an angle of inclination of a spindle motor 400, relative to fixed members, according to an exemplary embodiment in the present disclosure will be described with reference to FIGS. 1A through 3.

First, in the case in which the rotating member and the fixed member of the spindle motor are coupled to each other, it is preferable that the rotating member is coupled to the fixed member in a state in which it is not inclined (that is, in a state in which an angle of inclination of the rotating member is 0°, relative to fixed members) as shown in FIG. 1A. However, as shown in FIG. 1B, the rotating member may be coupled to the fixed member in a state in which it is inclined (at an angle of θ°) due to tolerance between the respective members, or the like.

In the case in which the rotating member rotates in the state in which it is inclined, relative to fixed members, an eccentricity phenomenon may occur, and vibrations and noise may be caused in the spindle motor.

In addition, a friction surface may be worn due to friction between the rotating member and the fixed member, which may have a negative influence on performance of the spindle motor.

Therefore, in the spindle motor 400 according to an exemplary embodiment in the present disclosure, a phenomenon that the rotor 200, the rotating member, rotates in a state in which it is eccentric is prevented, whereby an angle of inclination of the rotor 200, relative to fixed members, may be improved.

To this end, the spindle motor 400 according to an exemplary embodiment in the present disclosure may include a magnetic material 314 generating asymmetric pulling force (F2<F1) between the magnetic material 314 and the magnet 230.

The base member 310 may include a plurality of penetration holes 312 formed therein so as to penetrate therethrough, the magnetic material 314 may be inserted into at least one of the plurality of penetration holes 312, and non-magnetic materials 316 may be inserted into the penetration holes 312 other than the penetration hole 312 into which the magnetic material 314 is inserted. Also, the magnetic materials 314 having different magnetic forces from each other may be inserted into the plurality of penetration holes 312.

The penetration holes 312 may partially protrude from an upper surface of the base member 310, and the base member 310 may be sealed from the outside by the magnetic material 314 and the non-magnetic materials 316 inserted into the penetration holes 312.

Here, the magnetic material 314 may be disposed in a position corresponding to that of the magnet 230 to generate the pulling force between the magnetic material 314 and the magnet 230.

Since the magnetic material 314 and the non-magnetic materials 316 are respectively inserted into the plurality of penetration holes 312 formed in the base member 310, the asymmetric pulling force (F2<F1) may be generated between the magnetic and non-magnetic materials 314 and 316 and the magnet 230. Also, Since the magnetic materials 314 having different magnetic forces from each other are respectively inserted into the plurality of penetration holes 312 formed in the base member 310, the asymmetric pulling force (F2<F1) may be generated between the magnetic materials 314 and the magnet 230.

In the case in which the rotor 200 is assembled in a state in which it is inclined, a distance between the base member 310 and the rotor 200 may not be constant. That is, a portion of the rotor 200 relatively close to the base member 310 and a portion of the rotor 200 relatively distant from the base member 310 may be present.

Therefore, the magnetic material 314 may exert force on the portion of the rotor 200 relatively distant from the base member 310 by the asymmetric pulling force generated between the magnetic and non-magnetic materials 314 and 316 and the magnet 230, thereby improving the angle of inclination of a rotating member, relative to fixed members.

To this end, the magnetic material 314 may be disposed in a position corresponding to that of the magnet 230 and be disposed in a position corresponding to a portion of the rotor 200 inclined in the upward axial direction.

That is, the magnetic material 314 is disposed at the position corresponding to the portion of the rotor 200 inclined in the upward axial direction to pull the portion of the rotor 200 relatively distant from the base member 310 by the asymmetric pulling force (F2<F1) generated between the magnetic and non-magnetic materials 314 and 316 and the magnet 230, whereby the angle of inclination of the rotor 200, relative to fixed members, may be improved.

In addition, in the spindle motor 400 according to an exemplary embodiment, since the penetration holes 312 penetrate through the base member 310, the magnetic material 314 and the non-magnetic materials 316 may be inserted into the penetration holes 312, respectively, even after assembly of the spindle motor 400 is completed.

For example, after assembling the spindle motor 400 and then test-driving the spindle motor 400 to test whether or not the rotor 200 rotates in a state in which the rotor 200 is inclined, the magnetic material 314 and the non-magnetic materials 316 may be inserted into the penetration holes 312, respectively.

The magnetic material 314 may be inserted into the penetration hole 312 corresponding to the portion of the rotor 200 inclined in the upward axial direction so that the pulling force is generated at the portion of the rotor 200 inclined in the upward axial direction, and the non-magnetic materials 316 may be inserted into the penetration holes 312 other than the penetration hole 312 into which the magnetic material 314 is inserted.

Therefore, the asymmetric pulling force (F2<F1) is generated between the magnet 230 and the magnetic and non-magnetic materials 314 and 316, whereby the angle of inclination of the rotor 200, relative to fixed members, may be improved.

Hereinafter, a method of improving an angle of inclination of a spindle motor 400′, relative to fixed members, according to another exemplary embodiment in the present disclosure will be described with reference to FIGS. 4A through 5.

The spindle motor 400′ according to another exemplary embodiment in the present disclosure may be the same as the spindle motor 400 according to an exemplary embodiment in the present disclosure described above except that insertion grooves 312 instead of the penetration holes 312 are formed in a base member 310′.

Referring to FIGS. 4A through 5, a base member 310′ of the spindle motor 400′ according to another exemplary embodiment in the present disclosure may be provided with a plurality of insertion grooves 312′.

The magnetic material 314 may be inserted into at least one of the plurality of insertion grooves 312′ to generate asymmetric pulling force (F2<F1) between the magnetic material 314 and the magnet 230.

The non-magnetic materials 316 may be inserted into the insertion grooves 312′ other than the insertion groove 312′ into which the magnetic material 314 is inserted among the plurality of insertion grooves 312′.

Here, it may be optional as to whether or not the non-magnetic materials 316 are inserted.

That is, in the spindle motor 400 according to an exemplary embodiment in the present disclosure described above, since the penetration holes 312 penetrate through the base member 310, the non-magnetic materials 316 need to be inserted into the penetration holes 312 other than the penetration hole 312 into which the magnetic material 314 is inserted, thereby sealing the base member 310.

However, in the spindle motor 400′ according to another exemplary embodiment in the present disclosure, since the insertion grooves 312′ do not penetrate through the base member 310′, but are recessed from a lower surface of the base member 310′ toward an upper surface of the base member 310′, it may be optional whether or not the non-magnetic materials 316 are inserted.

Through the above-mentioned configuration, in the spindle motor 400′ according to another exemplary embodiment in the present disclosure, the asymmetric pulling force (F2<F1) is generated between the magnet 230 and the magnetic and non-magnetic materials 314 and 316, whereby the angle of inclination of the rotor 200, relative to fixed members, may be improved.

As set forth above, in the spindle motor according to exemplary embodiments in the present disclosure, a phenomenon that the rotating member rotates in a state in which it is inclined at the time of rotation of the spindle motor may be prevented, such that an angle of inclination, relative to fixed members, at the time of rotation of the spindle motor, may be improved.

While exemplary embodiments have been shown and described above, it will be apparent to those skilled in the art that modifications and variations could be made without departing from the scope of the present invention as defined by the appended claims.

What is claimed is:

1. A spindle motor comprising:
a sleeve rotatably supporting a shaft;
a rotor coupled to the shaft and rotating together therewith; and
a base member fixedly coupled to the sleeve,
wherein the base member includes a plurality of penetration holes formed therein so as to penetrate therethrough, and
a magnetic material is inserted into at least one of the plurality of penetration holes, and non-magnetic materials are inserted into the remaining penetration holes.

2. The spindle motor of claim 1, wherein the base member is formed by plastically deforming a steel sheet.

3. The spindle motor of claim 1, wherein the penetration holes partially protrude from an upper surface of the base member.

4. The spindle motor of claim 1, wherein the rotor has a magnet mounted on an inner peripheral surface thereof, and
the magnetic material is disposed in a position corresponding to that of the magnet.

5. The spindle motor of claim 1, wherein the magnetic material is disposed in a position corresponding to a portion of the rotor inclined in an upward axial direction.

6. A spindle motor comprising:
a sleeve rotatably supporting a shaft;
a rotor coupled to the shaft, rotating together therewith, and having a magnet mounted on an inner peripheral surface thereof; and
a base member fixedly coupled to the sleeve,
wherein the base member is provided with a magnetic material to generate asymmetric pulling force between the magnetic material and the magnet.

7. The spindle motor of claim 6, wherein the base member includes a plurality of insertion grooves formed therein, and the magnetic material is inserted into at least one of the plurality of insertion grooves.

8. The spindle motor of claim 7, wherein the insertion grooves are recessed from a lower surface of the base member toward an upper surface of the base member.

9. The spindle motor of claim 7, wherein non-magnetic materials are inserted into the insertion grooves other than the insertion groove into which the magnetic material is inserted among the plurality of insertion grooves.

10. The spindle motor of claim 6, wherein the magnetic material is disposed in a position corresponding to that of the magnet.

11. The spindle motor of claim 6, wherein the magnetic material is disposed in a position corresponding to a portion of the rotor inclined in an upward axial direction.
